(19) United States
(12) Patent Application Publication
(10) Pub. No.: US 2015/0331248 A1
(43) Pub. Date: Nov. 19, 2015

(54) Liquid Crystal Display Apparatus

(71) Applicant: SAKAI DISPLAY PRODUCTS CORPORATION, Sakai-shi, Osaka (JP)

(72) Inventors: Masae Kitayama, Sakai-shi, Osaka (JP); Kentaro Irie, Sakai-shi, Osaka (JP)

(21) Appl. No.: 14/758,180

(22) PCT Filed: Apr. 28, 2014
(86) PCT No.: PCT/JP2014/061861

§ 371 Date: Jun. 26, 2015

(30) Foreign Application Priority Data
May 17, 2013 (JP) 2013-105522

(51) Int. Cl. G02B 27/26; G02F 1/1335; G02F 1/13363; G02F 1/1343

(52) U.S. Cl. CPC G02B 27/26; G02F 1/134336; G02F 1/133528; G02F 1/13363

(57) ABSTRACT

A liquid crystal display apparatus which includes a liquid crystal panel including a plurality of pixels arranged in a matrix shape in a row direction and a column direction, and a retardation plate having a first polarization region which converts a polarization state of light transmitting through the liquid crystal panel into a first polarization state and a second polarization region which converts the polarization state thereof into a second polarization state different from the first polarization state, includes a plurality of picture elements including a plurality of first pixels which have a relatively high brightness in a prescribed gradation and are arranged in an oblique direction with respect to the row direction, and a plurality of second pixels which have a relatively low brightness in a predetermined gradation and are arranged adjacent to the first pixels, wherein the retardation plate is configured so that the first pixels in each of the picture elements face each other in the first polarization region and the second polarization region, and the picture elements including the first pixels facing each other in the first polarization region and the picture elements including the first pixels facing each other in the second polarization region are arranged in the row direction, respectively.

### CROSS-REFERENCE TO RELATED APPLICATIONS

This application is the national phase of PCT International Application No. PCT/JP2014/061861, which has an international filing date of Apr. 28, 2014, and designated the United States of America.

### FIELD

The present application relates to a liquid crystal display apparatus which displays a stereoscopic image by a passive system.

### BACKGROUND

As one stereoscopic image display system, a display system by a passive system (polarized glasses system) has been known in the art. In this display system, light emitted from a liquid crystal panel is changed into two polarization states different from each other, and by observing an image on a display screen through the polarized glasses in which a polarizing plate for transmitting only one polarized light is formed for the right eye, and a polarizing plate for transmitting only the other polarized light is formed for the left eye, the image may be viewed as the stereoscopic image (see for example, Japanese Patent Laid-open No. H10-253824).

In order to change the light emitted from the liquid crystal panel into the two polarization states different from each other, a patterned retardation film is used, for example. The patterned retardation film includes a patterned retardation layer in which regions having retardations different from each other are regularly arranged, and is configured in such a manner that, for example, by transmitting a linearly polarized light through the regions, the linearly polarized light transmitting through each of the regions is converted into two types of circularly polarized light (or elliptically polarized light) having polarization states different from each other.

If the above-described patterned retardation film is bonded to a liquid crystal panel, the linearly polarized light transmitting through the liquid crystal panel may be converted into two types of circularly polarized light (or elliptically polarized light) having polarization states different from each other.

Therefore, a right-eye image and a left-eye image are respectively displayed in one screen, and the right-eye image is converted into one polarization state, and the left-eye image is converted into the other polarization state, thereby, when observing an image on the display screen through the above-described polarized glasses, the image may be viewed as the stereoscopic image.

### SUMMARY

In the stereoscopic image display system by the passive system, a problem of a decrease in definition of a displayed image has been known in the art. For example, when the display apparatus has a resolution of full HD (i.e., 1920 dots×1080 lines), the right-eye image and the left-eye image for the 1920 dots×540 lines are respectively prepared, and then the right-eye image and the left-eye image are alternately displayed line by line. Therefore, definitions of the right-eye image and the left-eye image are respectively halved as compared with the case of displaying a two-dimensional image. As described above, the stereoscopic image display apparatus of the polarization system has a problem such as a decrease in definition of the stereoscopic image, specifically in a vertical direction.

In consideration of the above-mentioned circumstances, it is an object of the present application to provide a liquid crystal display apparatus which is capable of, in an apparatus for displaying a stereoscopic image by a passive system, suppressing a decrease in definition of the stereoscopic image.

A liquid crystal display apparatus according to the present application includes a liquid crystal panel including a plurality of pixels arranged in a matrix shape in a row direction and a column direction, and a retardation plate having a first polarization region which converts a polarization state of light transmitting through the liquid crystal panel into a first polarization state and a second polarization region which converts the polarization state thereof into a second polarization state different from the first polarization state, a plurality of picture elements including a plurality of first pixels which have a relatively high brightness in a prescribed gradation and are arranged in an oblique direction with respect to the row direction, and a plurality of second pixels which have a relatively low brightness in a predetermined gradation and are arranged adjacent to the first pixels, wherein the retardation plate is configured so that the first pixels in each of the picture elements face each other in the first polarization region and the second polarization region, and the picture elements including the first pixels facing each other in the first polarization region and the picture elements including the first pixels facing each other in the second polarization region are arranged in the row direction, respectively.

The liquid crystal display apparatus according to the present application, wherein the plurality of first pixels forming each of picture elements have a display color different from each other, and an arrangement of the display color of the first pixels in the picture elements facing each other in the first polarization region, and an arrangement of the display color of the first pixels in the picture elements of the second polarization region which display corresponding to the picture elements are made the same as each other.

The liquid crystal display apparatus according to the present application, wherein the first pixels facing each other in the first polarization region are configured to display a left-eye image (right-eye image), and the first pixels facing each other in the second polarization region are configured to display the right-eye image (left-eye image).

The liquid crystal display apparatus according the present application, wherein the retardation plate is configured so that a boundary between the first polarization region and the second polarization region faces the second pixels in the picture element.

According to the present application, in the apparatus for displaying a stereoscopic image by the passive system, it is possible to suppress a decrease in definition of the stereoscopic image. In addition, each picture element includes a plurality of bright sub-pixels (first pixels) and dark sub-pixels (second pixels), and even if the bright sub-pixels included in each picture element are arranged in an oblique direction, when displaying a straight line in a lateral direction, it is possible to prevent a disturbance in a straight line.

The above and further objects and features of the invention will more fully be apparent from the following detailed description with accompanying drawings.

### BRIEF DESCRIPTION OF DRAWINGS

FIG. 1 is a view illustrating a substantial configuration of a liquid crystal display apparatus according to an embodiment of the present application.

FIG. 2 is a cross-sectional view illustrating the liquid crystal display apparatus according to the embodiment of the present application.

FIG. 3 is a plan view illustrating an example of a FPR film.

FIG. 4 is a longitudinal-sectional view of the FPR film.

FIG. 5 is a schematic view illustrating a pixel pattern of a liquid crystal panel.

FIG. 6 is a view illustrating an equivalent circuit of a pixel.

FIG. 7 is a schematic view illustrating an arrangement relation between a pixel in a liquid crystal panel and first and second polarization regions in the FPR film.

FIGS. 8A and 8B are a schematic view describing an arrangement of a picture element according to Embodiment 1.

FIG. 9 is a schematic view describing the arrangement of the picture element according to Embodiment 1.

FIG. 10 is a view illustrating a display example when a straight line in a lateral direction is drawn on a display panel.

FIGS. 11A and 11B are a view describing a display example of a liquid crystal display apparatus in Comparative Example 1.

FIGS. 12A and 12B are a view describing a display example of a liquid crystal display apparatus in Comparative Example 2.

FIGS. 13A and 13B are a schematic view describing an arrangement of a picture element according to Embodiment 2.

FIG. 14 is a schematic view describing the arrangement of the picture element according to Embodiment 2.

FIGS. 15A and 15B are a schematic view describing an arrangement of a picture element according to Embodiment 3.

FIG. 16 is a schematic view describing the arrangement of the picture element according to Embodiment 3.

FIGS. 17A and 17B are a schematic view describing an arrangement of a picture element according to Embodiment 4.

FIG. 18 is a schematic view describing the arrangement of the picture element according to Embodiment 4.

### DESCRIPTION OF EMBODIMENTS

Hereinafter, the present application will be described in detail with reference to the accompanying drawings illustrating the embodiments thereof.

### Embodiment 1

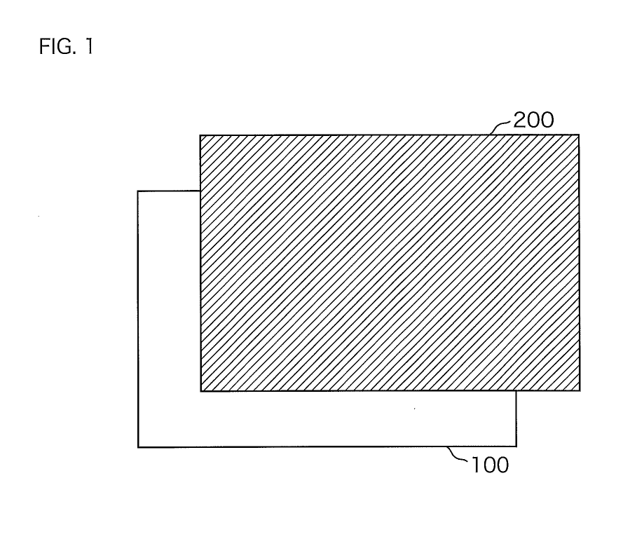

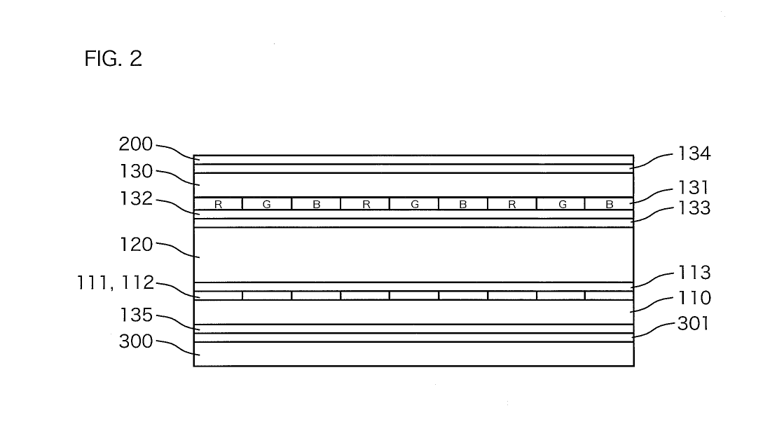

FIG. 1 is a view illustrating a substantial configuration of a liquid crystal display apparatus according to an embodiment of the present application, and FIG. 2 is a cross-sectional view illustrating the liquid crystal display apparatus according to the embodiment of the present application. The liquid crystal display apparatus according to the present embodiment includes a liquid crystal panel 100, a patterned retardation (FPR) film 200 (hereinafter, referred to as a FPR film) and a backlight unit 300.

The liquid crystal panel 100 includes a thin-film transistor (TFT)-side glass substrate 110, a liquid crystal layer 120 formed by a liquid crystal material sealed therein, a color filter (CF)-side glass substrate 130 and the like. Herein, the TFT-side glass substrate 110 includes a pixel electrode 111 corresponding to each pixel, a TFT 112 connected to the pixel electrode 111, and an alignment film 113, which are laminated on one surface side thereof.

In addition, the CF-side glass substrate 130 includes a color filter 131 including colored layers (not illustrated) for transmitting light of a color corresponding to respective colors of RGB, for example, and light shielding grids (not illustrated) which divide the colored layers into black matrixes of lattice-shaped pattern, a counter electrode 132 and an alignment film 133, which are laminated on one surface side thereof.

The liquid crystal panel 100 is provided with the backlight unit 300, a diffusion plate 301, and a polarizing plate 135 on a rear surface side (the other surface side of the TFT-side glass substrate 110) thereof. In addition, the liquid crystal panel 100 is provided with a polarizing plate 134 on a front surface side (the other surface side of the CF-side glass substrate 130) thereof.

The backlight unit 300 may include an edge light type backlight which has a light source for emitting light to a light guide plate from a side, and the light guide plate for emitting the light made incident thereon from the side to an LCD module side, and a direct type LED backlight which is provided with a plurality of LEDs arranged so as to face the TFT-side glass substrate 110.

The diffusion plate 301 is arranged between the polarizing plate 135 and the backlight unit 300, and has a function to diffuse light emitted from the backlight unit 300 to the liquid crystal panel 100 side.

The polarizing plate 135 is arranged on the front surface of the TFT-side glass substrate 110, and the polarizing plate 134 is arranged on the front surface of the CF-side glass substrate 130. The polarizing plates 134 and 135 are provided so as to transmit linearly polarized light perpendicular to each other.

By the above-described configuration, the linearly polarized light transmitting through the polarizing plate 135 of the light emitted from the backlight unit 300 passes through the liquid crystal layer 120 to be made incident on the polarizing plate 134 of the CF side. In this case, the polarization state of the light transmitting through the liquid crystal layer 120 may be changed depending on a voltage applied to the liquid crystal layer 120. Therefore, a voltage corresponding to an image signal is applied to the pixel electrode 111 and the counter electrode 132, and an electric field is applied to the liquid crystal layer 120, such that the polarization state of the light transmitting through the liquid crystal layer 120 is changed, and thereby an amount of the light transmitting through the polarizing plate 134 may be controlled to form an optical image.

The liquid crystal display apparatus according to the present embodiment includes the FPR film 200 to allow the stereoscopic image display, aside from the polarizing plates 134 and 135 provided on both sides of the liquid crystal panel 100. The FPR film 200 converts the linearly polarized light transmitting through the polarizing plates 134 and 135 into two types of polarized light (for example, left circularly polarized light having a polarizing axis whose rotating direction is a left direction, and right circularly polarized light having a polarizing axis whose rotating direction is a right direction).

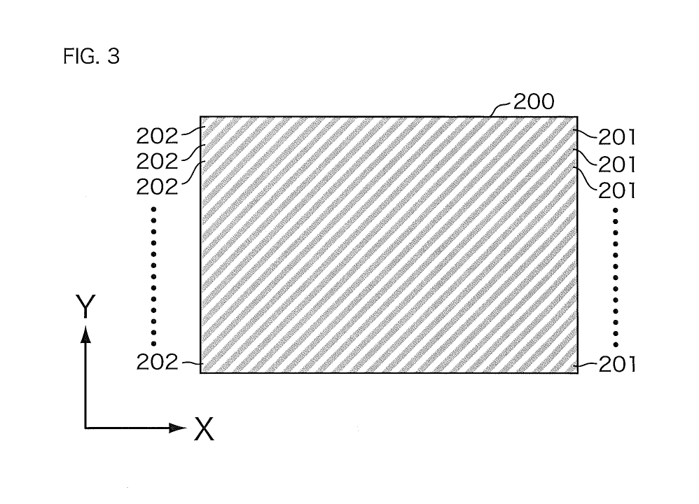

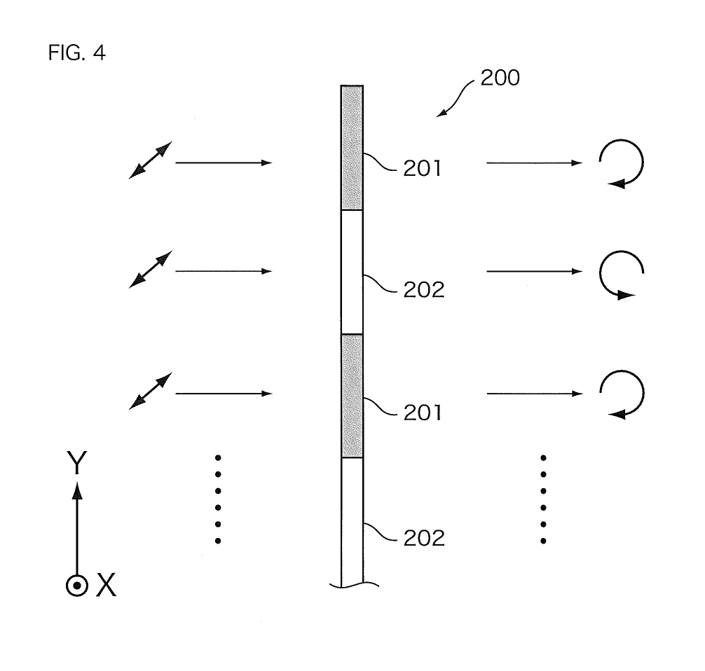

FIG. 3 is a plan view illustrating an example of the FPR film 200, and FIG. 4 is a longitudinal-sectional view thereof. The FPR film 200 includes, for example, first polarization regions 201 and second polarization regions 202, in which at least one of in-plane slow axis and in-plane retardation is different from each other, and has a strip-shaped pattern in which these first polarization regions 201 and the second polarization regions 202 are alternately arranged. The first polarization regions 201 and the second polarization regions 202 have, as illustrated in FIG. 3, a strip shape extending in an oblique direction (for example, a direction of a slope of 45 degrees) with respect to an X-axis direction (row direction), respectively. The FPR film 200 converts the linearly polarized light transmitting through the first polarization regions 201 into the left circularly polarized light, for example, and converts the linearly polarized light transmitting through the second polarization regions 202 into the right circularly polarized light, for example, thereby creating two types of polarization state different from each other.

The strip-shaped pattern in the FPR film 200 is set depending on positions of the pixels included in the liquid crystal panel 100. In addition, an interval between the first polarization region 201 and the second polarization region 202 may be set in accordance with dimensions of the pixels. When displaying the stereoscopic image by the passive system, a right-eye image to be observed by the right eye and a left-eye image to be observed by the left eye are displayed in the display region of the liquid crystal panel 100. By associating one of these right-eye image and the left-eye image with the first polarization regions 201 of the FPR film 200, and associating the other thereof with the second polarization regions 202 of the FPR film 200, so that the right-eye image may have optical characteristics of the right circularly polarized light (or left circularly polarized light), and the left-eye image may have the optical characteristics of the left circularly polarized light (or right circularly polarized light). As a result, by transmitting the polarized light through the polarized glasses in which a polarizing plate for transmitting only one polarized light is formed for the right eye, and a polarizing plate for transmitting only the other polarized light is formed for the left eye, the viewer may view the stereoscopic image.

Hereinafter, a relation between the pixels included in the liquid crystal panel 100 and the first and second polarization regions 201 and 202 in the FPR film 200 will be described.

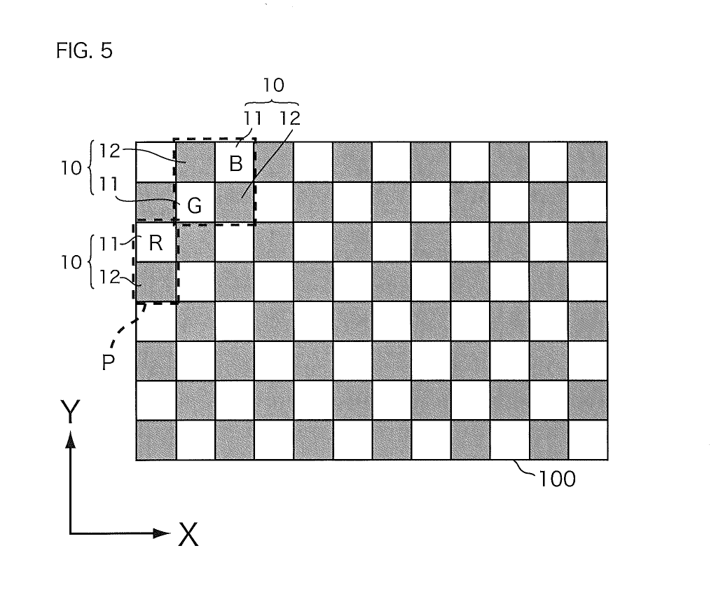

FIG. 5 is a schematic view illustrating a pixel pattern of a liquid crystal panel 100. Each pixel 10 of the liquid crystal panel 100 includes a first pixel (bright sub-pixel 11) having a relatively high brightness in a prescribed gradation, and a second pixel (dark sub-pixel 12) having a relatively low brightness in a prescribed gradation. In the present embodiment, the bright sub-pixels 11 and the dark sub-pixels 12 are alternately arranged in the row direction (X direction in FIG. 5) and a column direction (Y direction in FIG. 5), respectively, to form the pixel pattern as illustrated in FIG. 5.

Herein, a picture element P which is a display unit of the liquid crystal panel 100 includes the pixels 10 of respective colors of RGB one by one. In the example illustrated in FIG. 5, one picture element P is formed by three pixels of the pixel 10 (R pixel) including the bright sub-pixel 11 at a third row and a first column and the dark sub-pixel 12 at a fourth row and the first column, the pixel 10 (G pixel) including the dark sub-pixel 12 at a first row and a second column and the bright sub-pixel 11 at a second row and the second column, and the pixel 10 (B pixel) including the bright sub-pixel 11 at the first row and a third column and the dark sub-pixel 12 at the second row and the third column. Further, an arrangement of the picture element P will be described below.

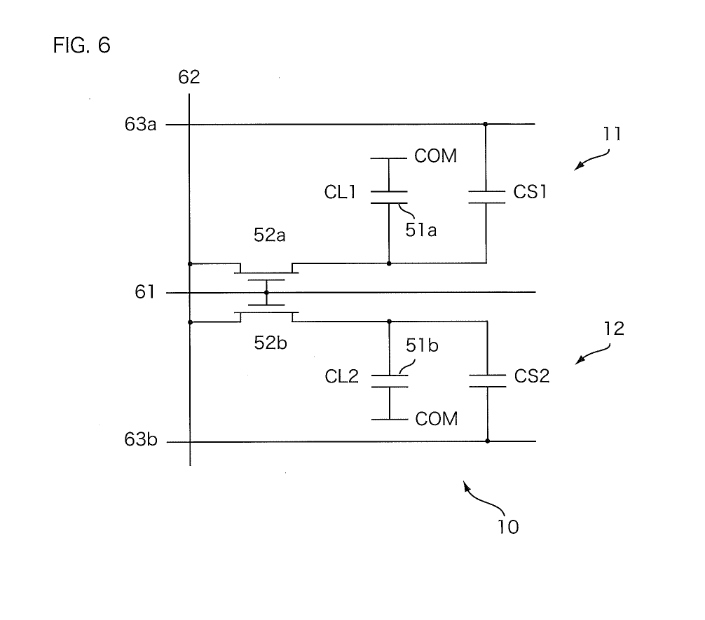

FIG. 6 is a view illustrating an equivalent circuit of the pixel 10. One pixel 10 includes a first sub-pixel electrode 51a and a second sub-pixel electrode 51b. The first sub-pixel electrode 51a is connected to a scanning signal line 61 and a data signal line 62 through a first transistor 52a. The second sub-pixel electrode 51b is connected to the scanning signal line 61 and the data signal line 62 through a second transistor 52b. A first liquid crystal capacitor CL1 is formed between the first sub-pixel electrode 51a and the counter electrode COM, and a second liquid crystal capacitor CL2 is formed between the second sub-pixel electrode 51b and the counter electrode COM. A first holding capacitor CS1 is formed between the first sub-pixel electrode 51a and a first holding capacitor wiring 63a, and a second holding capacitor CS2 is formed between the second sub-pixel electrode 51b and the second holding capacitor wiring 63b.

A source signal voltage (display signal voltage and data signal) from the common data signal line 62 is previously supplied to the first sub-pixel electrode 51a and the second sub-pixel electrode 51b, thereafter, the respective transistors 52a and 52b are turned off, and then voltages of the first holding capacitor wiring 63a and the second holding capacitor wiring 63b are changed so as to be different from each other. Thereby, the voltages applied to the first liquid crystal capacitor CL1 and the second liquid crystal capacitor CL2 are different from each other, and the bright sub-pixel 11 having relatively high brightness, and the dark sub-pixel 12 having relatively low brightness are formed in the one pixel 10.

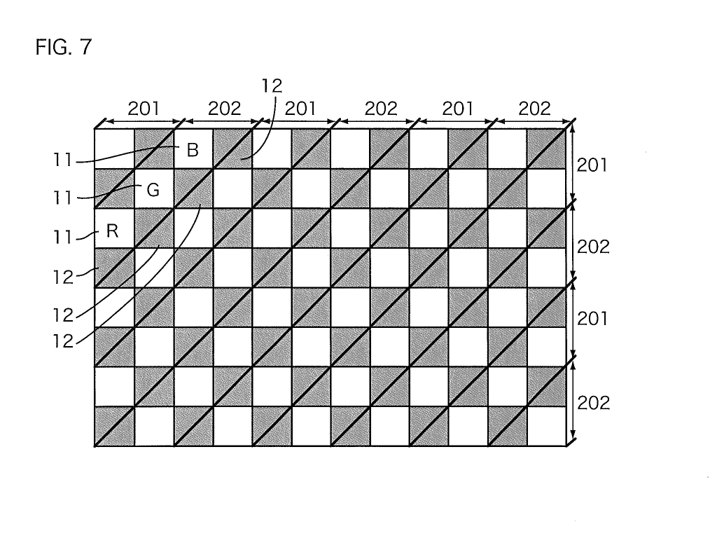

FIG. 7 is a schematic view illustrating an arrangement relation between the pixel 10 in the liquid crystal panel 100 and the first and second polarization regions 201 and 202 in the FPR film 200. In the present embodiment, since the bright sub-pixels 11 and the dark sub-pixels 12 are alternately arranged in the row and column directions, the bright sub-pixels 11 of the respective colors of RGB and the dark sub-pixels 12 of the respective colors of RGB are linearly continued in the oblique direction. Moreover, the first polarization regions 201 and the second polarization regions 202 of the FPR film 200 are formed so as to face each line in the oblique direction formed by the bright sub-pixels 11. In addition, boundaries between the first polarization regions 201 and the second polarization regions 202 of the FPR film 200 are configured so as to be located on each line in the oblique direction formed by the dark sub-pixels 12.

As described above, in the liquid crystal panel 100 in which the bright sub-pixels 11 and the dark sub-pixels 12 are arranged in a matrix shape in the row and column directions, the bright sub-pixels 11 alternately display the right-eye image and the left-eye image for each line which are linearly arranged in the oblique direction, thereby it is possible to provide the optical characteristics of the right circularly polarized light (or left circularly polarized light) to the right-eye image, and the optical characteristics of the left circularly polarized light (or right circularly polarized light) to the left-eye image.

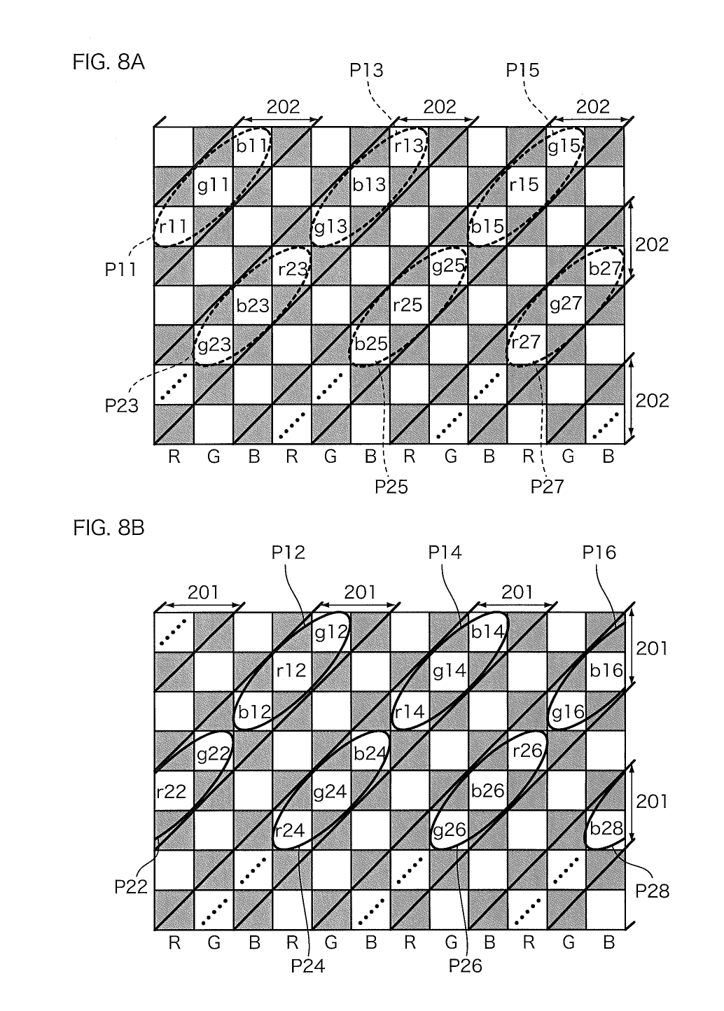

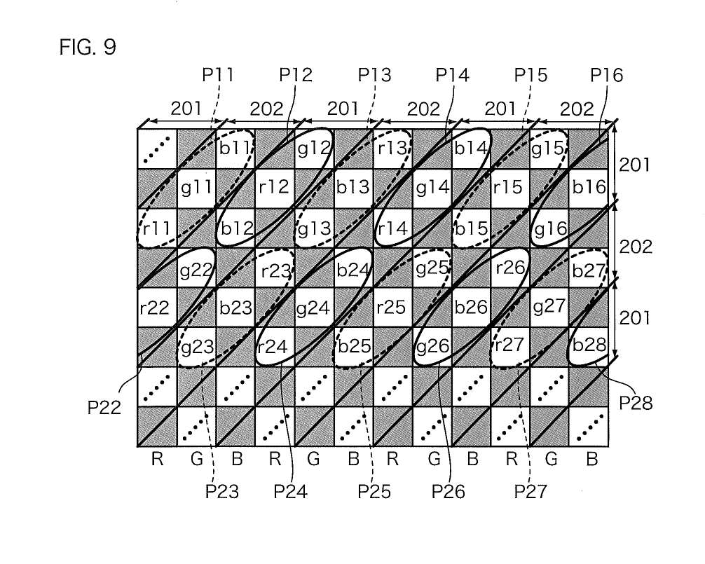

FIGS. 8A, 8B and 9 are schematic views describing an arrangement of the picture element according to Embodiment 1. In FIGS. 8A and 8B, the picture elements (picture elements P11, P13, . . . ) overlapped in the second polarization regions 202, and the picture elements (picture elements P12, P14, . . . ) overlapped in the first polarization regions 201 are described separately for the convenience of explanation. FIG. 9 describes both of the picture elements (picture elements P11, P13, . . . ) overlapped in the second polarization regions 202 and the picture elements (picture elements P12, P14, . . . ) overlapped in the first polarization regions 201.

FIG. 8A illustrates the arrangement of the picture elements (picture elements P11, P13, . . . ) overlapped in the second polarization regions 202. The picture element P11 includes three bright sub-pixels r11, g11 and b11 and three dark sub-pixels respectively corresponding thereto, and the bright sub-pixels r11, g11 and b11 forming the picture element P11 are configured so as to be located on the line in the oblique direction overlapped in the second polarization regions 202. Further, for simplicity, in the following drawings, by designating three bright sub-pixels forming each picture element, it is assumed to indicate the position of each picture element. Other picture elements P13, P15, P23, P25, P27, . . . , etc. are similar thereto, and for example, the bright sub-pixels g13, b13 and r13 forming the picture element P13, and the bright sub-pixels g23, b23 and r23 forming the picture element P23 are located on one line in the oblique direction overlapped in the second polarization regions 202.

FIG. 8B illustrates the arrangement of the picture elements (picture elements P12, P14, . . . ) overlapped in the first polarization regions 201. The picture element P12 includes three bright sub-pixels b12, r12 and g12 and three dark sub-pixels corresponding thereto, and the bright sub-pixels b12, r12 and g12 forming the picture element P12 are configured so as to be located on the line in the oblique direction overlapped in the first polarization regions 201. Other picture elements P14, P16, P22, P24, P26, P28 . . . , etc. are similar thereto, and for example, bright sub-pixels r14, g14 and b14 forming the picture element P14, and bright sub-pixels r24, g24 and b24 forming the picture element P24 are located on one line in the oblique direction overlapped in the first polarization regions 201.

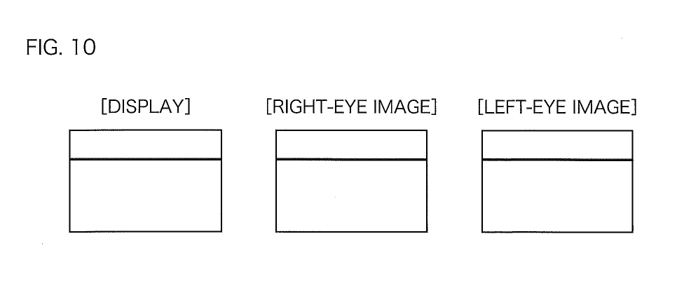

According to Embodiment 1, as illustrated in FIGS. 8A and 8B, the picture elements P11, P13, P15, . . . located in the second polarization regions 202, and the picture elements P12, P14, P16, . . . located in the first polarization regions 201 are configured so as to be linearly arranged in the respective row directions. FIG. 10 is a view illustrating a display example when a straight line in a lateral direction is drawn on the display panel. In addition, the picture elements (for example, P11 and P12, P13 and P14, P15 and P16, . . . ) adjacent to each other in the row direction are also configured so as to be linearly arranged in the row direction. Therefore, when drawing a straight line in the lateral direction on the liquid crystal panel 100 using these picture elements P11, P12, P13, . . . , as illustrated in the display example of FIG. 10, the right-eye image and the left-eye image may be viewed as one straight line without a disturbance.

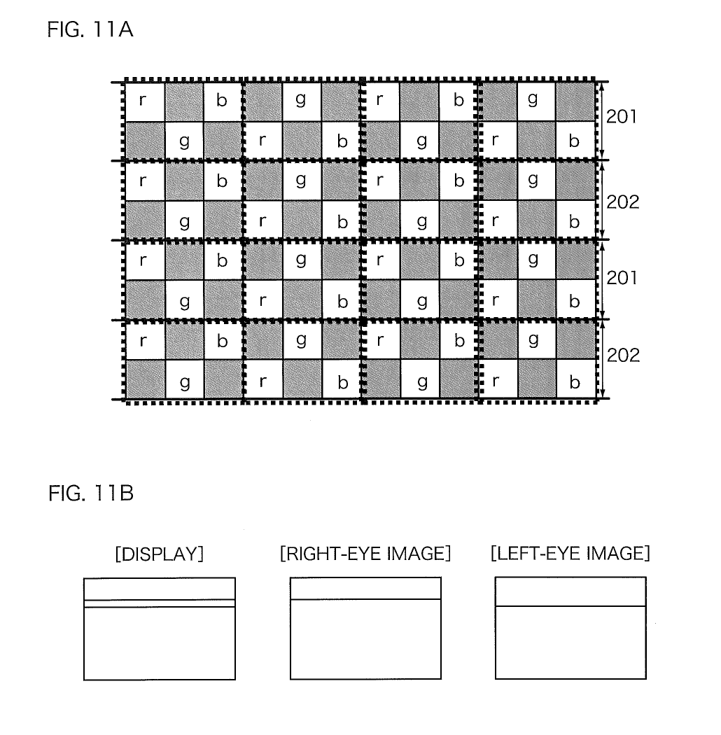

Hereinafter, two comparative examples will be described as reference. FIGS. 11A and 11B are a view describing a display example of a liquid crystal display apparatus in Comparative Example 1. FIG. 11A illustrates the arrangement of the picture elements in Comparative Example 1. Each picture element is formed by the bright sub-pixels and the dark sub-pixels of the respective colors of RGB, and is arranged in the row direction. In addition, by associating with the picture elements of each row, the first polarization regions 201 and the second polarization regions 202 are alternately provided for each line, and by converting the right-eye image into one polarization state, and converting the left-eye image into the other polarization state, the stereoscopic image display is achieved.

In the liquid crystal display apparatus having the above-described configuration, when drawing a straight line in the lateral direction on the display panel, as illustrated in FIG. 11B, it is necessary to prepare linear images for each of the right-eye image and the left-eye image. By using the polarized glasses including the polarizing plate for transmitting only the right-eye image and the polarizing plate for transmitting only the left-eye image, the right-eye image is viewed as a straight line by the right eye, and the left-eye image is viewed as a straight line by the left eye.

In Comparative Example 1, the straight line drawn on the display panel may be viewed as a straight line by a user, but since the pixel arrangement of the two rows is used as one scan line, it can be seen that the display resolution in the lateral direction is reduced to one half.

On the other hand, according to Embodiment 1, the direction in which the bright sub-pixels 11 and the dark sub-pixels 12 are arranged is set to be the oblique direction, and the first polarization regions 201 and the second polarization regions 202 of the FPR film 200 are provided by associating with the line in the oblique direction by the bright sub-pixel 11, thereby it is possible to prevent a decrease in display resolution, while suppressing an occurrence of crosstalk.

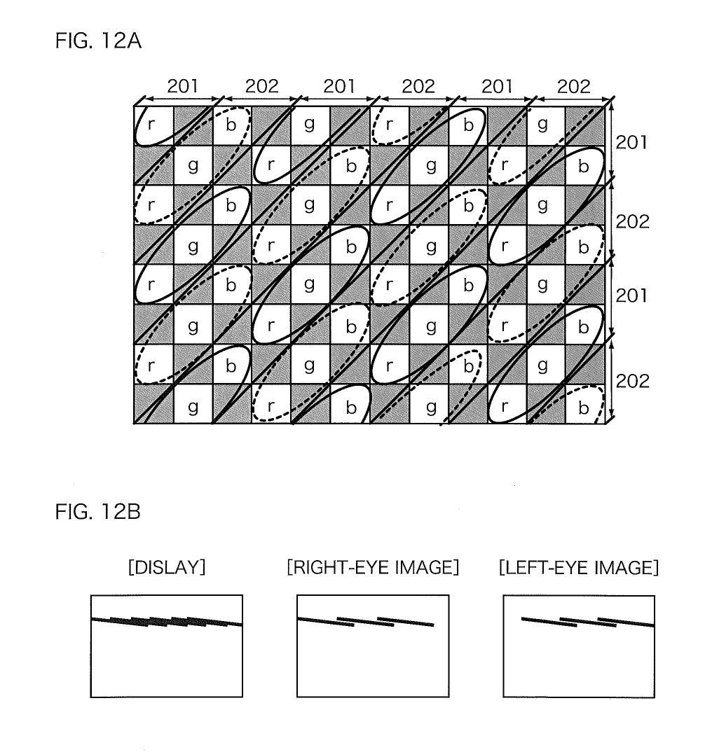

FIGS. 12A and 12B are a view describing a display example of a liquid crystal display apparatus in Comparative Example 2. FIG. 12A illustrates the arrangement of the picture elements in Comparative Example 2. In Comparative Example 2, the bright sub-pixels and the dark sub-pixels of the respective colors of RGB arranged in the oblique direction are used, and the first polarization regions 201 and the second polarization regions 202 are provided by associating with the bright sub-pixels in the oblique direction. Herein, in Comparative Example 2, each picture element formed by the bright sub-pixels and the dark sub-pixels of the respective colors of RGB is arranged in a longitudinal direction.

In Comparative Example 2, the configuration in which the bright sub-pixels and the dark sub-pixels of the respective colors of RGB are arranged in the oblique direction is the same as that of Embodiment 1, but the arrangement of the picture element is different from that of Embodiment 1. Therefore, when drawing a straight line in the lateral direction in the liquid crystal display apparatus of Comparative Example 2, there is a need to select several pixels that are not arranged on the straight line, so as to be viewed as a straight line in a pseudo manner as illustrated in FIG. 12B.

On the other hand, according to Embodiment 1, as illustrated in FIG. 8, since the picture elements P11, P13, P15, . . . facing each other in the second polarization regions 202, and the picture elements P12, P14, P16, . . . facing each other in the first polarization regions 201 are linearly arranged in the row direction, respectively, when drawing a straight line in the lateral direction using these picture elements P11, P12, P13, . . . on the liquid crystal panel 100, it is possible to display as a continuous straight line without a disturbance.

Further, the arrangement of the picture element is not limited to the configuration illustrated in FIGS. 8A and 8B. Hereinafter, a modified example of the arrangement of the picture element in the liquid crystal panel 100 will be described.

### Embodiment 2

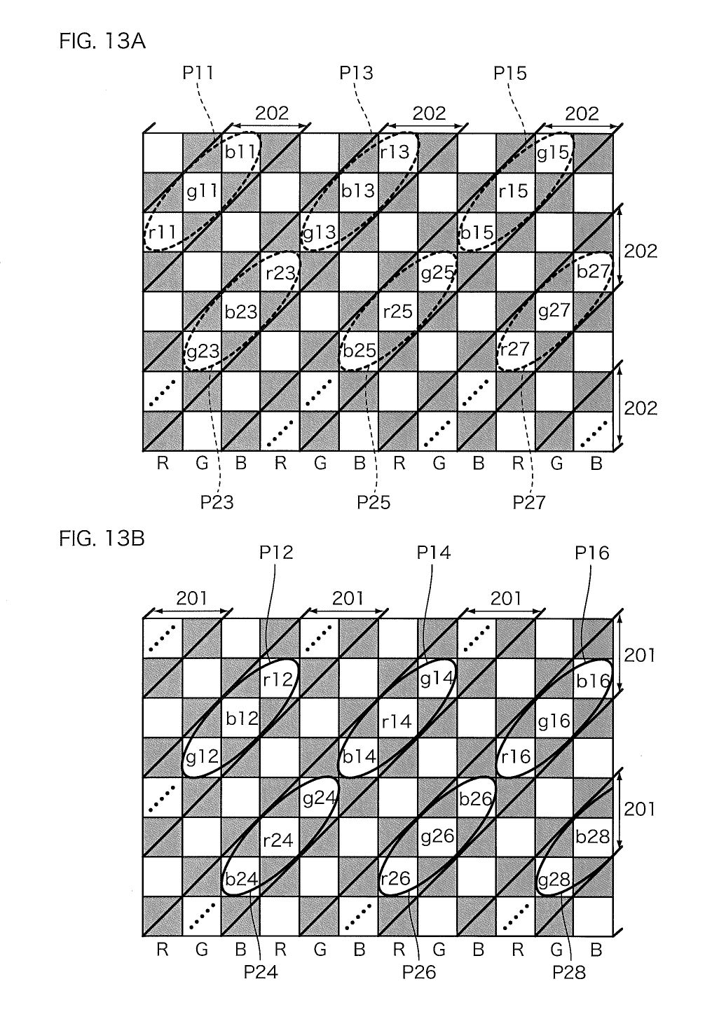

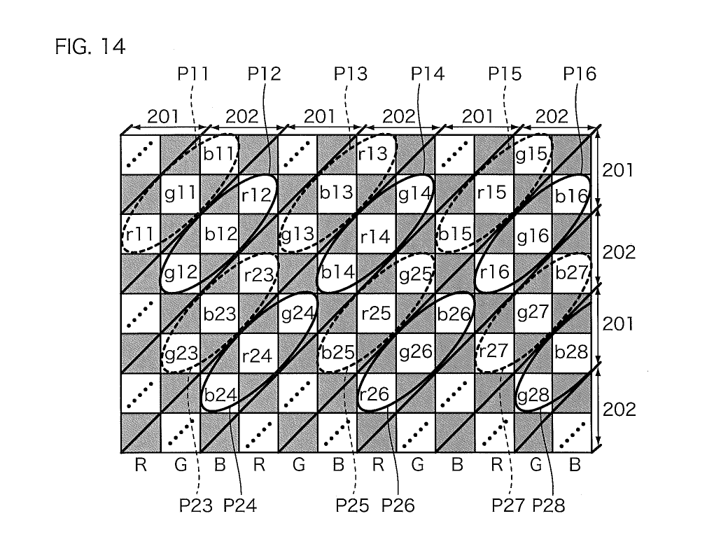

FIGS. 13A, 13B and 14 are schematic views describing an arrangement of a picture element according to Embodiment 2. In FIGS. 13A and 13B, the picture elements (picture elements P11, P13, . . . ) overlapped in the second polarization regions 202, and the picture elements (picture elements P12, P14, . . . ) overlapped in the first polarization regions 201 are described separately for the convenience of explanation. FIG. 14 describes both of the picture elements (picture elements P11, P13, . . . ) overlapped in the second polarization regions 202 and the picture elements (picture elements P12, P14, . . . ) overlapped in the first polarization regions 201.

FIG. 13A illustrates the arrangement of the picture elements (picture elements P11, P13, . . . ) overlapped in the second polarization regions 202. The picture element P11 includes three bright sub-pixels r11, g11 and b11 and three dark sub-pixels corresponding thereto, and the bright sub-pixels r11, g11 and b11 forming the picture element P11 are configured so as to be located on the line in the oblique direction overlapped in the second polarization regions 202. Other picture elements P13, P15, P23, P25, P27, . . . , etc. are similar thereto, and for example, the bright sub-pixels g13, b13 and r13 forming the picture element P13, and the bright sub-pixels g23, b23 and r23 forming the picture element P23 are located on one line in the oblique direction overlapped in the second polarization regions 202.

FIG. 13B illustrates the arrangement of the picture elements (picture elements P12, P14, . . . ) overlapped in the first polarization regions 201. The picture element P12 includes three bright sub-pixels g12, b12 and r12 and three dark sub-pixels corresponding thereto, and the bright sub-pixels g12, b12 and r12 forming the picture element P12 are located on the line in the oblique direction overlapped in the first polarization regions 201. Other picture elements P14, P16, P24, P26, P28, . . . , etc. are similar thereto.

Embodiment 2 is configured in such a manner that, as illustrated in FIGS. 13A and 13B, the picture elements P11, P13, . . . facing each other in the second polarization regions 202 of the FPR film 200, and the picture elements P12, P14, . . . facing each other in the first polarization regions 201 are arranged side by side (on the same straight line in the row direction), respectively. On the other hand, as illustrated in FIG. 14, the picture elements (for example, P11 and P12, P13 and P14, P15 and P16, . . . ) adjacent to each other in the row direction are not arranged on the same straight line, and the arrangement of the picture elements P11, P12, P13, P14, . . . is defined so that the upper and lower boundaries between the respective picture elements P11, P12, P13, P14, . . . are positioned on the same straight line in the lateral direction, respectively.

According to Embodiment 2, the picture elements P11, P12, P13, P14, . . . are not arranged on the completely same straight line, but the upper and lower boundaries between the respective picture elements P11, P12, P13, P14, . . . are located on the same straight line in the lateral direction, and thereby, when drawing a straight line in the lateral direction on the display panel 100 as the right-eye image and the left-eye image, it is possible to display as a straight line without a disturbance.

### Embodiment 3

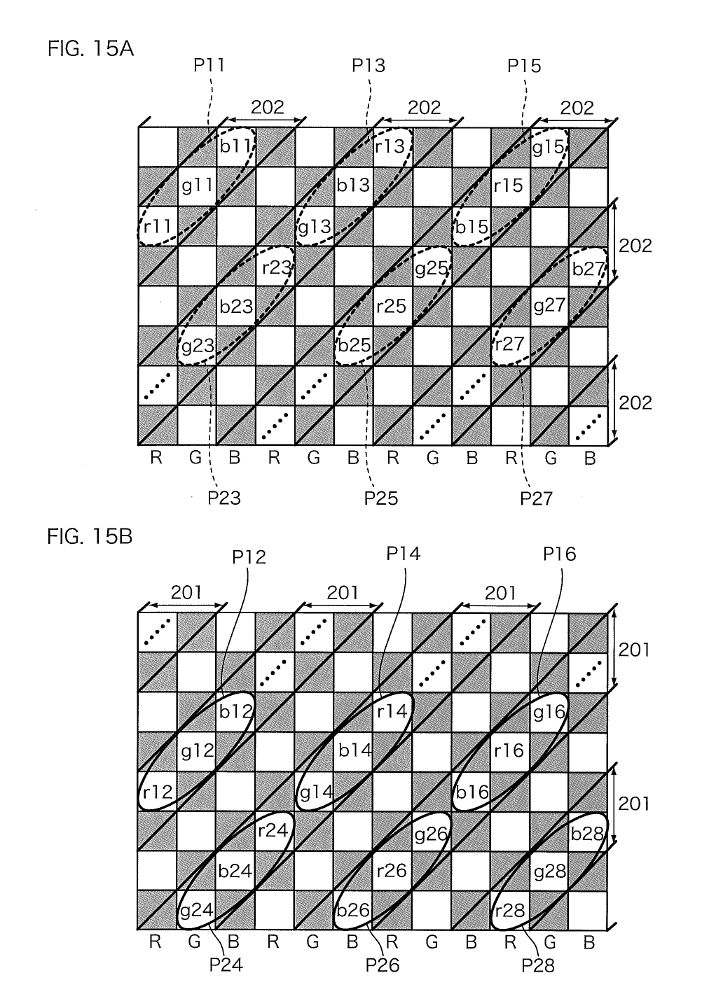

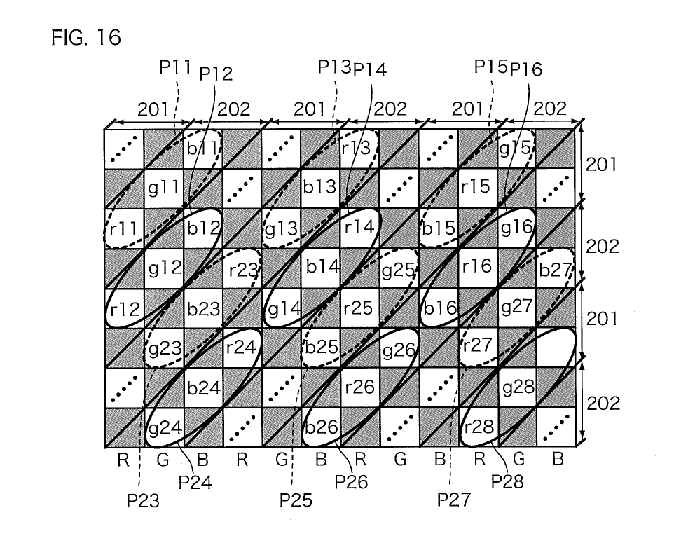

FIGS. 15A, 15B and 16 are schematic views describing an arrangement of a picture element according to Embodiment 3. In FIGS. 15A and 15B, the picture elements (picture elements P11, P13, . . . ) overlapped in the second polarization regions 202, and the picture elements (picture elements P12, P14, . . . ) overlapped in the first polarization regions 201 are described separately for the convenience of explanation. FIG. 16 describes both of the picture elements (picture elements P11, P13, . . . ) overlapped in the second polarization regions 202 and the picture elements (picture elements P12, P14, . . . ) overlapped in the first polarization regions 201.

FIG. 15A illustrates the arrangement of the picture elements (picture elements P11, P13, . . . ) overlapped in the second polarization regions 202. The picture element P11 includes three bright sub-pixels r11, g11 and b11 and three dark sub-pixels corresponding thereto, and the bright sub-pixels r11, g11 and b11 forming the picture element P11 are configured so as to be located on the line in the oblique direction overlapped in the second polarization regions 202. Other picture elements P13, P15, P23, P25, P27, . . . , etc. are similar thereto, and for example, the bright sub-pixels g13, b13 and r13 forming the picture element P13, and the bright sub-pixels g23, b23 and r23 forming the picture element P23 are located on one line in the oblique direction overlapped in the second polarization regions 202.

FIG. 15B illustrates the arrangement of the picture elements (picture elements P12, P14, . . . ) overlapped in the first polarization regions 201. The picture element P12 includes three bright sub-pixels r12, g12 and b12 and three dark sub-pixels corresponding thereto, and the bright sub-pixels r12, g12 and b12 forming the picture element P12 are located on the line in the oblique direction overlapped in the first polarization regions 201. Other picture elements P14, P16, P24, P26, P28, . . . , etc. are similar thereto.

According to Embodiment 3, as illustrated in FIGS. 15A and 15B, the picture elements P11, P13, . . . facing each other in the second polarization regions 202 of the FPR film 200, and the picture elements P12, P14, . . . facing each other in the first polarization regions 201 are arranged side by side, respectively. On the other hand, as illustrated in FIG. 16, the picture elements (for example, P11 and P12, P13 and P14, P15 and P16, . . . ) adjacent to each other in the row direction are not located on the same straight line, and the arrangement of the upper and lower boundaries between the respective picture elements P11, P12, P13, P14, . . . is defined so that each picture element P11, P12, P13, P14, . . . is positioned on the same straight line in the lateral direction, respectively. Therefore, when drawing a straight line in the lateral direction on the display panel 100 as the right-eye image and the left-eye image, it is possible to display as a straight line without a disturbance.

Furthermore, according to Embodiment 3, in the picture element on which the right-eye image is displayed, and the picture element on which the left-eye image is displayed corresponding to the picture element, the arrangement of the bright sub-pixels of the respective colors of RGB may be made the same as each other. For example, the picture element P13 located in the second polarization regions 202 has a sequential arrangement of (g13, b13 and r13) from the lower left, and the picture element P14 located in the first polarization regions 201 corresponding thereto also has a sequential arrangement of (g14, b14 and r14) from the lower left. As described above, in the picture element on which the right-eye image is displayed, and the picture element on which the left-eye image is displayed corresponding to the picture element, since the arrangement of the bright sub-pixels of the respective colors of RGB may be made the same as each other, according to Embodiment 3, it is possible to display the image with little abnormal feeling.

### Embodiment 4

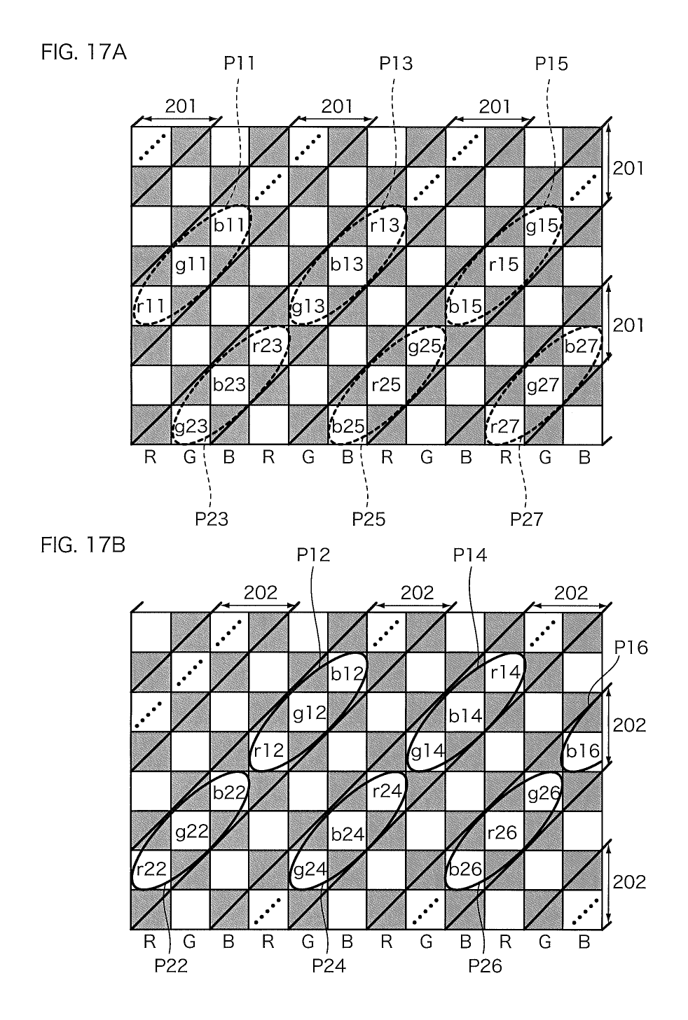

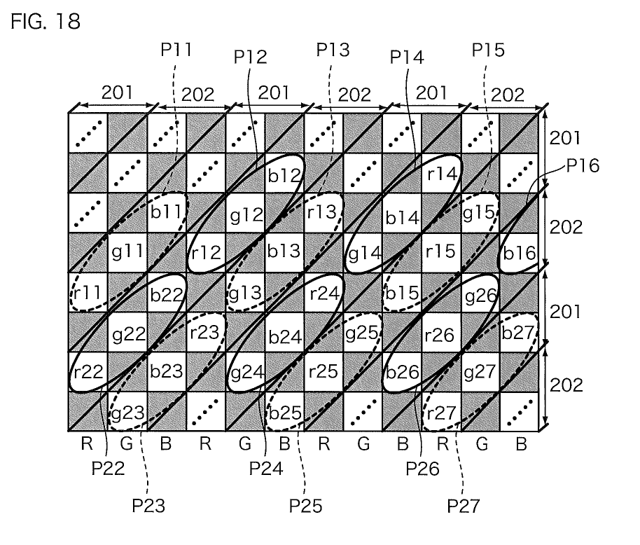

FIGS. 17A, 17B and 18 are schematic views describing an arrangement of a picture element according to Embodiment 4. In FIGS. 17A and 17B, the picture elements (picture elements P11, P13, . . . ) overlapped in the first polarization regions 201, and the picture elements (picture elements P12, P14, . . . ) overlapped in the second polarization regions 202 are described separately for the convenience of explanation. FIG. 18 describes both of the picture elements (picture elements P11, P13, . . . ) overlapped in the first polarization regions 201 and the picture elements (picture elements P12, P14, . . . ) overlapped in the second polarization regions 202.

FIG. 17A illustrates the arrangement of the picture elements (picture elements P11, P13, . . . ) overlapped in the first polarization regions 201. The picture element P11 includes three bright sub-pixels r11, g11 and b11 and three dark sub-pixels corresponding thereto, and the bright sub-pixels r11, g11 and b11 forming the picture element P11 are configured so as to be located on the line in the oblique direction overlapped in the first polarization regions 201. Other picture elements P13, P15, P23, P25, P27 . . . , etc. are similar thereto.

FIG. 17B illustrates the arrangement of the picture elements overlapped in the second polarization regions 202 (picture elements P12, P14, . . . ). The picture element P12 includes three bright sub-pixels r12, g12 and b12 and three dark sub-pixels corresponding thereto, and the bright sub-pixels r12, g12 and b12 forming the picture element P12 are located on the line in the oblique direction overlapped in the second polarization regions 202. Other picture elements P14, P16, P22, P24, P26 . . . , etc. are similar thereto.

According to Embodiment 4, as illustrated in FIGS. 17A and 17B, the picture elements P11, P13, . . . facing each other in the first polarization regions 201 of the FPR film 200, and the opposite picture elements P12, P14, . . . facing each other in the second polarization regions 202 are configured to be arranged side by side, respectively. On the other hand, as illustrated in FIG. 18, the picture elements (for example, P11 and P12, P13 and P14, P15 and P16, . . . ) adjacent to each other in the row direction are not located on the same straight line, and the arrangement of the picture elements P11, P12, P13, P14, . . . is defined so that the upper and lower boundaries between the respective picture elements P11, P12, P13, P14, . . . are positioned on the same straight line in the lateral direction, respectively. Therefore, when drawing a straight line in the lateral direction on the display panel 100 as the right-eye image and the left-eye image, it is possible to display as a straight line without a disturbance.

Furthermore, according to Embodiment 4, in the picture element on which the right-eye image is displayed, and the picture element on which the left-eye image is displayed corresponding to the picture element, the arrangement of the bright sub-pixels of the respective colors of RGB may be made the same as each other. For example, the picture element P11 located in the first polarization regions 201 has a sequential arrangement of (r11, g11 and b11) from the lower left, and the picture element P12 located in the second polarization regions 202 corresponding thereto also has a sequential arrangement of (r12, g12 and b12) from the lower left. As described above, in the picture element on which the right-eye image is displayed, and the picture element on which the left-eye image is displayed corresponding to the picture element, since the arrangement of the bright sub-pixels of the respective colors of RGB may be made the same as each other, according to Embodiment 4, it is possible to display the image with little abnormal feeling.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims. In addition, the technical features described in each embodiment may be combined with each other.

1-4. (canceled)

5. A liquid crystal display apparatus comprising:
a liquid crystal panel including a plurality of pixels arranged in a matrix shape in a row direction and a column direction;
a retardation plate having a first polarization region which converts a polarization state of light transmitting through the liquid crystal panel into a first polarization state and a second polarization region which converts the polarization state thereof into a second polarization state different from the first polarization state; and
a plurality of picture elements including a plurality of first pixels which have a relatively high brightness in a prescribed gradation and are arranged in an oblique direction with respect to the row direction, and a plurality of second pixels which have a relatively low brightness in a predetermined gradation and are arranged adjacent to the first pixels, wherein
the retardation plate is configured so that the first pixels in each of the picture elements face each other in the first polarization region and the second polarization region, and
the picture elements including the first pixels facing each other in the first polarization region and the picture elements including the first pixels facing each other in the second polarization region are arranged in the row direction, respectively.

6. The liquid crystal display apparatus according to claim 5, wherein the plurality of first pixels forming each of picture elements have a display color different from each other, and
an arrangement of the display color of the first pixels in the picture elements facing each other in the first polarization region, and an arrangement of the display color of the first pixels in the picture elements of the second polarization region which display corresponding to the picture elements are made the same as each other.

7. The liquid crystal display apparatus according to claim 5, wherein the first pixels facing each other in the first polarization region are configured to display a left-eye image (right-eye image), and the first pixels facing each other in the second polarization region are configured to display the right-eye image (left-eye image).

8. The liquid crystal display apparatus according to claim 7, wherein the retardation plate is configured so that a boundary between the first polarization region and the second polarization region faces the second pixels in the picture element.
